(19) United States
(12) Patent Application Publication
(10) Pub. No.: US 2009/0184068 A1
(43) Pub. Date: Jul. 23, 2009

(54) Clip Assemblies for Rug Display Systems

(75) Inventor: Henry R. Kin, West Chester, OH (US)

Correspondence Address: DINSMORE & SHOHL, LLP, 1900 CHEMED CENTER, 255 EAST FIFTH STREET, CINCINNATI, OH, 45202, US

(73) Assignee: KIN PRODUCTS, LLC, West Chester, OH (US)

(21) Appl. No.: 12/017,599

(22) Filed: Jan. 22, 2008

(51) Int. Cl. F16B 2/18; A47F 7/16; F16B 2/10; A44B 21/00

(52) U.S. Cl. 211/45; 24/457; 24/517

(57) ABSTRACT

Clip assemblies for securing articles to frames include a clip body having a first end and a second end, the first end having an engagement surface, a clip lever moveably secured to the clip body having a handle and a clip claw rotatably associated with the clip body and moveable to and away from the engagement surface of the clip body, wherein at least a portion of the handle of clip lever is located above the clip claw so that when the clip assembly in an engaged position, the handle is substantially flush with at least a portion of the clip body.

### TECHNICAL FIELD

The invention relates to systems and components for displaying rugs, and more particularly, to clip assemblies and associated rug display systems that enable rugs secured within the clip assemblies to be easily and effectively secured to and removed from such rug display systems.

### BACKGROUND

The typical consumer of area rugs desires to view the entire rug prior to purchase. With larger sizes of area rugs, display and access to full view inspection is often space prohibitive. Rugs may be displayed on a surface stacked on one another. However, due to the size and weight of most rugs, the rugs are often difficult to maneuver, and thus, do not allow the consumer to conveniently obtain a complete view of the front and back sides of the rug. Heretofore, it has been known to display rugs with hanging assemblies, wherein the rugs are supported in hanging relation by a plurality of rotatable rug hangers and movable toward and away from each other so as to allow a consumer to obtain a view of the rug.

To secure rugs to such hanging systems, attachment clamps have been provided. Issues arise with such attachment clamps, however, in that these clamps can cause damage to the rugs displayed from the systems. For example, because such clamps generally include sharp hooks located on both sides of the rug (e.g., the backing and the face layer), hooks placed on the face layer can damage the rug by pulling the yarn within the layer. In addition, operation of conventional attachment clamps is difficult and release mechanisms associated with such clamps are typically positioned in a manner wherein the rug may be unintentionally disengaged from the clamp when moving the rug during viewing.

Accordingly, there is a desire for clip assemblies for rug display systems which are easy to operate, reliable and prevent damage to the rug.

### SUMMARY

In one embodiment a clip assembly for securing an article therein includes a clip body having a first end and a second end, the first end having an engagement surface, a clip lever moveably secured to the clip body having a handle and a clip claw rotatably associated with the clip body and moveable to and away from the engagement surface of the clip body, wherein at least a portion of the handle of clip lever is located above the clip claw so that when the clip assembly in an engaged position, the handle is substantially flush with at least a portion of the clip body.

In another embodiment a clip assembly for securing an article therein includes a clip body having a first end and a second end, the first end having an engagement surface, a clip lever moveably secured to the clip body having a handle and a clip claw rotatably associated with the clip body and moveable to and away from the engagement surface of the clip body, wherein when the clip assembly is in the engaged position and mounted to a frame of an article display system, at least a portion of the handle is located between the frame and the clip body.

In yet another embodiment a display system for displaying articles includes a system base having a frame rotatably mounted to the base and a clip assembly configured to be mounted to the frame, the clip assembly for securing an article therein including a clip body having a first end and a second end, the first end having an engagement surface, a clip lever moveably secured to the clip body having a handle and a clip claw moveably associated with the clip body and moveable to and away from the engagement surface of the clip body, wherein at least a portion of the handle of clip lever is located above the clip claw so that when the clip assembly in an engaged position, the handle is substantially flush with at least a portion of the clip body.

These and additional features can be more fully understood in view of the following detailed description, in conjunction with the drawings.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a perspective view of an exemplary clip assembly in an unengaged position according to one embodiment of the present invention;

FIG. 2 is a perspective view of an exemplary clip assembly mounted on an exemplary crossbar in an engaged position according to one embodiment of the present invention;

FIG. 3 is a perspective exploded view of exemplary components of an exemplary clip assembly according to one embodiment of the present invention;

FIG. 4 is a bottom view of an exemplary clip assembly according to one embodiment of the present invention;

FIG. 5 is a side view of an exemplary clip assembly according to one embodiment of the present invention;

FIG. 6 is a perspective view of an exemplary rug display system comprising a plurality of clip assemblies according to one embodiment of the present invention; and

FIG. 6A is a perspective view of a expanded section of FIG. 6 according to one embodiment of the present invention.

### DETAILED DESCRIPTION

As will be discussed in relation to the drawing figures, clip assemblies may generally comprise a clip body, a clip lever and a clip claw each associated with one another to provide an assembly to secure a rug (e.g., when the assembly is in an engaged position) and release/position a rug (e.g., when the assembly in an unengaged position) with respect to a rug display system. It should be understood, however, that clip assemblies described herein can be utilized to secure a number of articles or items from a number of article display systems.

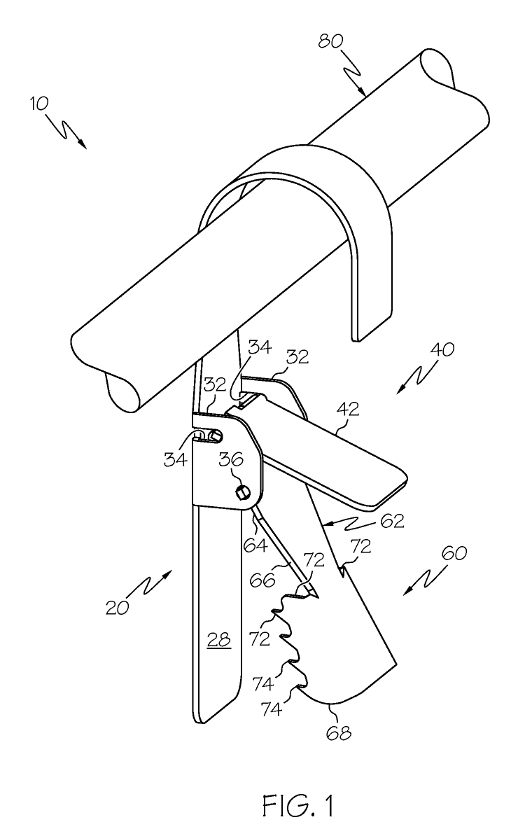

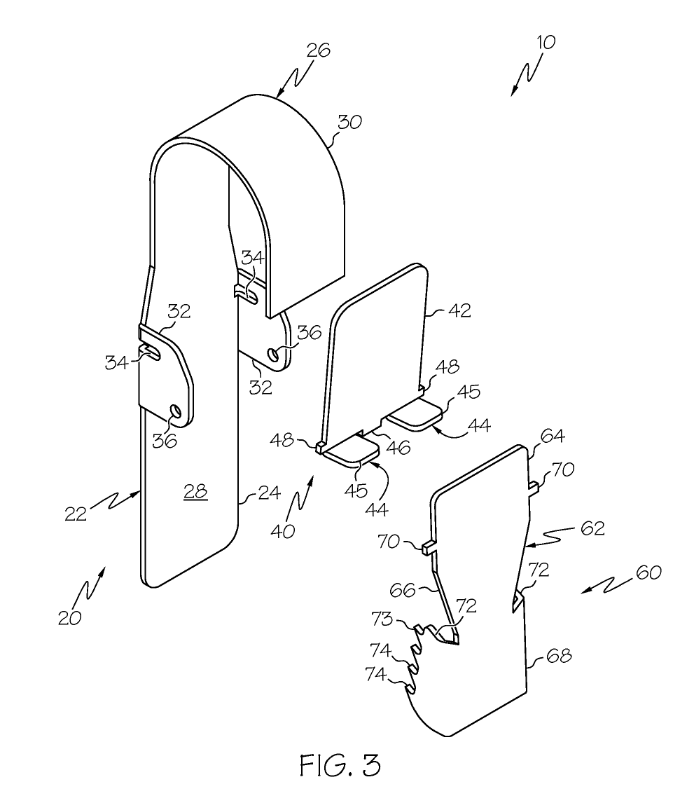

Referring to FIGS. 1-3, clip assemblies 10 may comprise a clip body 20, a clip lever 40 and a clip claw 60 (FIG. 3 illustrates an exploded view of the clip assembly 10). In one embodiment, the clip body 20, clip lever 40 and clip claw 60 may be comprised of spring steel, however, any material can be utilized. It is believed that spring steel will provide deflection to allow clip assemblies described herein to secure rugs having a variety of thicknesses.

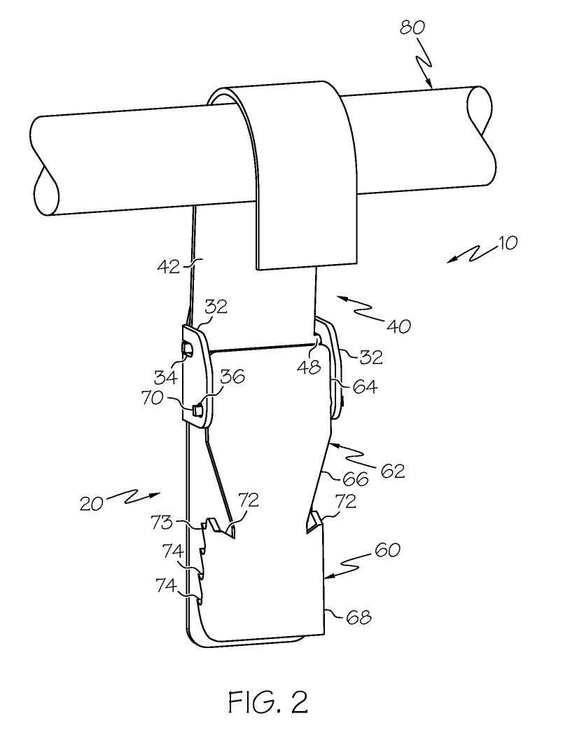

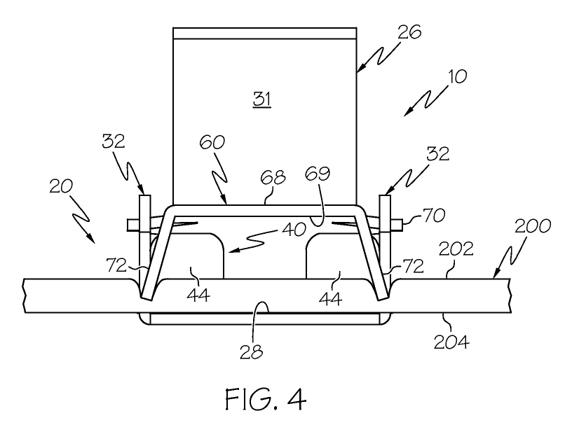

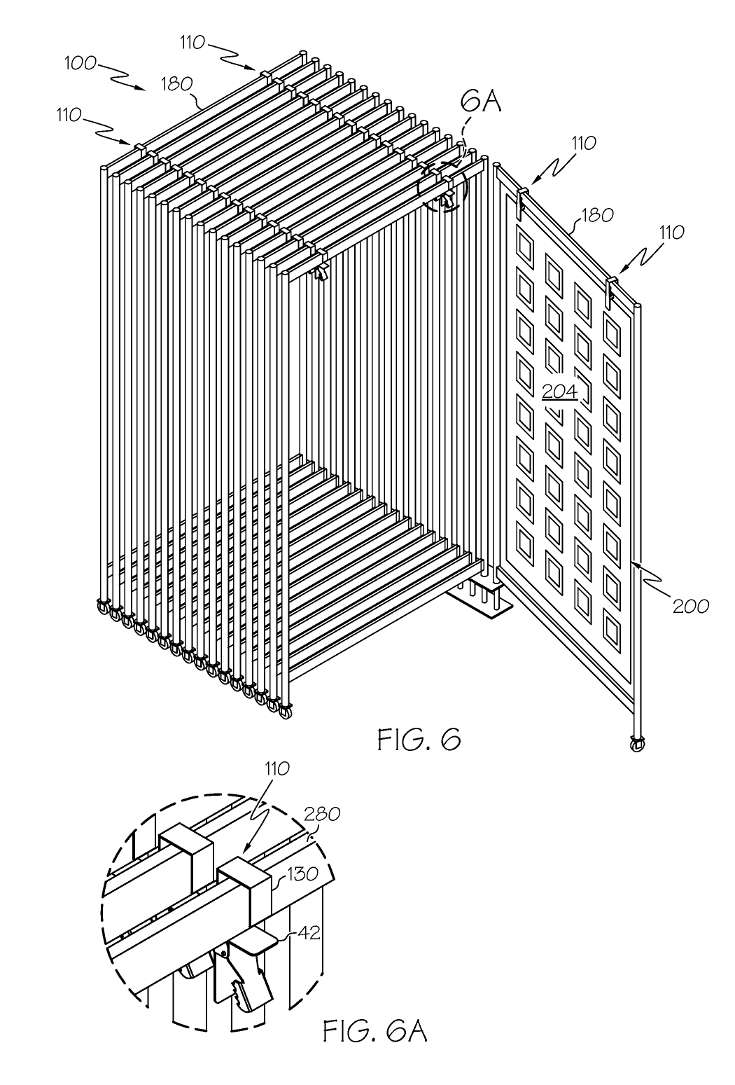

Referring to the drawings, clip body 20 may comprise a base 22 having a first end 24 and a second end 26. As illustrated, clip body 20 may taper inwardly as it extends from the first end 24 to the second end 26. First end 24 may comprise an engagement surface 28 to provide a contact surface with clip claw 60, such as when in an engaged position without a rug (or other article) secured therein, as discussed later herein. As illustrated, engagement surface 28 may be wider than mounting surface 32 (see FIG. 4). Second end 26 of base 22 may comprise mounting member 30. Mounting member 30 may be utilized to mount clip assembly 10 and any rug secured therein to a frame 80 of a rug display system 100 (see FIG. 6). As illustrated in FIGS. 1 and 2, mounting member 30 may be generally rounded so as to be mounted to a rounded frame 80, such as at mounting surface 31 (see FIG. 4). Alternatively, as best illustrated in FIG. 6A, clip assembly 110 may comprise a generally square shaped mounting member 130, such as when being mounted to a square shaped frame 180. Of course, any shape and/or configuration of the mounting member may be utilized depending on the compatible frame and/or rug display system.

Still referring to FIGS. 1-3, clip body 20 may also comprise first and second arms 32 extending outwardly from base 20. In one embodiment, such as that illustrated, arms 32 may be integral with base 20, wherein arms 32 have been folded to the desired orientation. Each of arms 32 may comprise a slot 34 and an aperture 36 for receiving clip lever 40 and clip claw 60 as discussed later herein. In addition, slot 34 may at least partially extend into base 20 to provide additional movement/positioning of clip lever.

Referring to FIG. 3, clip lever 40 may comprise a handle 42 and first and second legs 44. In another embodiment, clip lever 40 may comprise just one leg, such as one that extends outwardly from the center of the proximate end of handle. Each of first and second legs 44 comprise contact surfaces 45 for contacting an underside 69 of clip claw 60 such as when clip assembly 10 is in an engaged position (e.g., FIGS. 2 and 4), as discussed later herein. In addition, clip lever 40 may comprise stop member 46 and lever ears 48. Lever ears 48 may be movably engaged (e.g., slidably and rotatably) within slots 34 of arms 32 to facilitate movement of the clip lever toward and away from clip body 20 such as when moving the clip assembly 10 between engaged and unengaged positions (e.g., FIG. 1 illustrating an unengaged position and FIG. 2 illustrating an engaged position). Stop member 46 may provide a fulcrum when moving the clip assembly 10 from an engaged to an unengaged position as well as a stop preventing the handle from moving to an unengaged position, whereas first and second legs 44 provide a fulcrum when moving the clip assembly 10 from an unengaged to an engaged position.

Referring to FIGS. 1-4, clip assembly may also comprise a clip claw 60. Clip claw 60 may comprise a claw base 62 having a proximate portion 64, central portion 66 and distal portion 68. Proximate portion 64 may comprise a pair of fingers 70 extending laterally from the claw base 62. Lateral fingers fit within apertures 36 of arms 32 of clip body 20 so that clip claw can be moveable (e.g., rotatably moved) between engaged and unengaged positions. As illustrated, claw base 62 tapers from proximate portion 64 to distal portion 68 (e.g., such as through central portion 66).

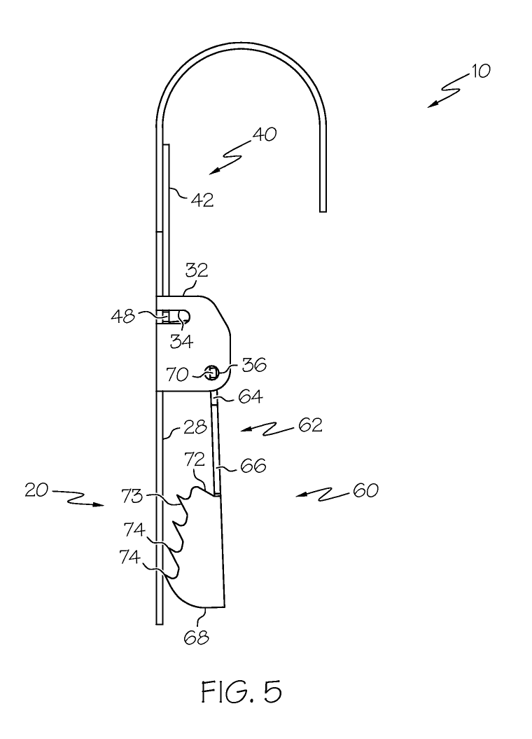

Distal portion 68 of claw base 62 may comprise a set of arms 32 extending toward the engagement surface 28 of the clip body 20. As illustrated in FIG. 4, arms 32 may be outwardly tapered toward the outer perimeter of clip body 20. In addition, the distal ends of the arms 32 may comprise one or more teeth 74 that generally extend diagonally from the distal portion 68 of claw base 62 to the proximate portion 64 of claw base 62. For example, referring to FIG. 5, when in an engaged position (and without a rug secured therein), the tooth 74 located toward the distal end of distal portion 68 is set lower or closer to the engagement surface 28 of clip body 20 than the tooth 73 located toward the proximate end of distal portion 68. In such an embodiment, the tooth 73 located toward the proximate end of distal portion 68 would generally be the first tooth to contact a rug when a rug is inserted and the clip assembly is moved to an engaged position. Such a configuration of offset or diagonally disposed teeth with respect to the clip body facilitates securing rugs of various thicknesses. In addition, having four rows of teeth works to distribute the force holding the rugs over multiple fibers, thereby reducing damage to any one fiber. Of course, in another embodiment, one or more teeth can be disposed in any configuration capable of securing a rug for display and a rug display system.

Referring to FIG. 6, an individual may secure a rug 200 utilizing clip assemblies 110 (or 10 as shown in FIGS. 1-5), and the clip assemblies 110 may be hung from a portion of a frame 180 (or 80 in FIGS. 1 and 2) of a rug display system 100. For example, referring to FIGS. 1-6A, a clip assembly 10 and 110 may be hung from a frame 80 and 180 in an unengaged position (FIG. 1), an engaged position (FIG. 2) or free from the frame in an engaged or unengaged position, the clip assembly not securing a rug. Particularly, clip lever 40, while moveable through a range of motion, can be in a position where it is flush with the clip body 20 (such as in an engaged position, see FIG. 2), 90° with respect to the clip body 20 (such as in an unengaged position, see FIG. 6A) or 110° with respect to the clip body 20 (also in an engaged position, see FIG. 1). While it is contemplated that the clip assembly will be removable from the frame when it is flush with the clip body 20 (such as in an engaged position) or 110° with respect to the clip body 20 (such as in an unengaged position) because distance between the mounting member 30 and the handle 42 provided clearance for frame, it should be understood that a variety of mounting member/handle configurations could provide clearance for a frame in many different handle orientations.

The clip assembly 10 and 110 may be moved to an unengaged position so as to be ready to accept a rug (see FIGS. 1 and 6A). A rug may be inserted between clip body 20 (e.g., engagement surface 28) and clip claw 60 and be moved toward and into abutting relationship (if desired) with arms 32 of clip body 20. Thereafter, an individual may push clip claw 60 toward clip body 20 (or, the claw may fall with gravity) wherein fingers 70 of clip claw 60 rotate within apertures 36 of clip body arms 36, thereby bringing first and second legs 44 of clip lever 40 into contact with underside 69 of clip claw 60. At this point, clip lever 40 can be at an approximately 45°-90° angle with respect to the clip base 22, depending on the orientation of the clip assembly 10 and 110 with at least a portion of the first and second legs 44 of clip lever 40 in contact with underside 69 of clip claw 60.

To move the clip assembly into an engaged position, handle 42 of clip lever 40 may be forced toward the clip body 20. During such motion, the top of the handle 42 travels under the mounting member 30 via sliding rotation of lever ears 48 within slots 34 of arms 32 (compare unengaged and engaged positions in FIGS. 1 and 5, respectively). In addition, during such motion, contact surfaces 45 of clip lever 40 contact the underside 69 of clip claw 60, the contact surfaces 45 of clip lever 40 force teeth 74 of clip claw into the backing 202 of rug 200 and toward engagement surface 28 (e.g., through the effective fulcrum of fingers 70/apertures 36). As illustrated in FIG. 5, handle 42, or a portion thereof, may lie flush, against clip body (or in another embodiment, may slightly offset from clip body 20 (e.g., substantially flush)).

Referring to FIG. 5, as clip assembly 10 is moved from an unengaged position to an engaged position, the tooth 73 located toward the proximate end of distal portion 68 would generally be the first tooth to contact a rug when a rug is inserted and the clip assembly is moved to an engaged position. Such a configuration coupled with the materials that can be utilized to manufacture the clip assemblies described herein (e.g., spring steel) allows the clip assemblies to secure rugs of various thicknesses.

In addition, as illustrated in FIGS. 4 and 6, clip assemblies described herein are intended to be used such that the clip claw 60 and teeth 74 contact the backing side 202 of rug 200, rather than the pile side 204 of the rug 200. In such a configuration, damage to the pile side 204 created by teeth 74 pulling yarn is prevented. However, in another embodiment, perhaps where the rug is manufactured without a pile side, clip claw, and ultimately, clip assembly can be oriented in any relationship relative to the rug.

Once a rug is inserted into clip assemblies and clip assemblies are in an engaged position as described herein, the rug and clip assembly may be hung from a rug display system, such as that illustrated in FIG. 6. For example, as illustrated rug 200 and clip assembly 110 (illustrated with a square mounting member 130 for mating relationship with square frame 180) may by mounted to frame 180 of rug display system 100.

Referring to FIGS. 2 and 6 (FIG. 2 illustrating a round mounting member 30 for mating relationship with rounded frame 130), when clip assembly 10 and 110 is in a mounted position relative to the frame 80 and 180, at least a portion of handle 42 of clip lever 40 is positioned between the frame 80 and 180 the clip body 20. In such an orientation, handle 42 can not be moved to move the clip assembly 10 and 110 to an unengaged position until the clip assembly is dismounted from the frame 80 and 180. Such a configuration helps prevent accidental disengagement of a rug secured within a clip assembly and mounted to a rug display system such as when the rug is pulled outward (e.g., because at least a portion of the handle is located above the rug, the rug does not contact handle that could otherwise trigger an accidental release.

Referring to FIGS. 1-6, clip assemblies may be moved from an engaged, mounted position (whether securing a rug or empty) to an unengaged position by first dismounting the clip assembly from the frame 80 and 180 or rug display system. In one embodiment, such as described above, at least a portion of handle 42 of clip lever 40 can be manufactured so that it is wider than second end 26 of clip body 20 (or clip body 20 manufactured so that it is less wide than at least a portion of handle 42 of clip lever 40). Such configuration allows a user to grasp the handle 42 (such as at or around the lateral perimeter) apart from the clip body 20, such as when moving the clip assembly from an engaged position to an unengaged position.

The handle 42 can be pulled away from the clip body 20 and under the mounting member 30 via sliding rotation of lever ears 48 within slots 34 of arms 32 (compare unengaged and engaged positions in FIGS. 1 and 5, respectively). In addition, during such motion, contact surfaces 45 of clip lever 40 decrease and eventually cease contact with the underside 69 of clip claw 60, which in turn, allows teeth 74 of clip claw to move away from the backing 202 of rug 200 and/or away from engagement surface 28.

The foregoing description of the various embodiments of the invention has been presented for the purposes of illustration and description. It is not intended to be exhaustive or to limit the invention to the precise form disclosed. Many alternatives, modifications and variations will be apparent to those skilled in the art of the above teaching. For example, clip assemblies in accordance with the present invention may secure rugs of varying sizes and shapes and be used with a number of different rug display systems. Accordingly, while some of the alternative embodiments of the clip assemblies have been discussed specifically, other embodiments will be apparent or relatively easily developed by those of ordinary skill in the art. Accordingly, this invention is intended to embrace all alternatives, modifications and variations that have been discussed herein, and others that fall within the spirit and broad scope of the claims.

What is claimed is:

1. A clip assembly for securing an article therein comprising:
a clip body having a first end and a second end, the first end having an engagement surface;
a clip lever moveably secured to the clip body having a handle; and
a clip claw rotatably associated with the clip body and moveable to and away from the engagement surface of the clip body, wherein at least a portion of the handle of clip lever is located above the clip claw so that when the clip assembly in an engaged position, the handle is substantially flush with at least a portion of the clip body.

2. The clip assembly of claim 1, wherein the second end of the clip body comprises a mounting member for removably mounting the clip assembly to a frame of an article display system.

3. The clip assembly of claim 1, wherein the clip lever comprises an outwardly extending leg having a contact surface.

4. The clip assembly of claim 3, wherein when the clip assembly is in the engaged position, at least a portion of the contact surface contacts an underside of the clip claw.

5. The clip assembly of claim 1, wherein when the clip assembly is in the engaged position and mounted to a frame of an article display system, at least a portion of the handle is located between the frame and the clip body.

6. The clip assembly of claim 1, wherein the clip body comprises first and second arms, each of the arms comprising a slot and an aperture.

7. The clip assembly of claim 6, wherein the clip lever comprises lever ears slidably engaged within the slots of the first and second arms.

8. The clip assembly of claim 6, wherein the clip claw comprises fingers rotatably secured within the apertures of the first and second arms.

9. The clip assembly of claim 1, wherein the clip assembly is comprised of spring steel.

10. The clip assembly of claim 1, wherein the clip claw comprises a claw base and a plurality of teeth extending diagonally from a distal portion of claw base to a proximate portion of claw base.

11. The clip assembly of claim 1, wherein the clip body does not comprise teeth.

12. A clip assembly for securing an article therein comprising:
a clip body having a first end and a second end, the first end having an engagement surface;
a clip lever moveably secured to the clip body having a handle; and
a clip claw rotatably associated with the clip body and moveable to and away from the engagement surface of the clip body, wherein when the clip assembly is in the engaged position and mounted to a frame of an article display system, at least a portion of the handle is located between the frame and the clip body.

13. The clip assembly of claim 1, wherein at least a portion of the handle of clip lever is located above the clip claw so that when the clip assembly in the engaged position, the handle is substantially flush with at least a portion of the clip body.

14. The clip assembly of claim 12, wherein the clip lever comprises an extending leg having a contact surface.

15. The clip assembly of claim 14, wherein when the clip assembly is in the engaged position, at least a portion of the contact surface contacts an underside of the clip claw.

16. The clip assembly of claim 12, wherein the clip body comprises first and second arms, each of the arms comprising a slot and an aperture.

17. The clip assembly of claim 16, wherein the clip lever comprises lever ears slidably engaged within the slots of the first and second arms.

18. The clip assembly of claim 16, wherein the clip claw comprises fingers rotatably secured within the apertures of the first and second arms.

19. A display system for displaying articles comprising:
a system base having a frame rotatably mounted to the base; and
a clip assembly configured to be mounted to the frame, the clip assembly for securing an article therein comprising:
a clip body having a first end and a second end, the first end having an engagement surface;
a clip lever moveably secured to the clip body having a handle; and
a clip claw moveably associated with the clip body and moveable to and away from the engagement surface of the clip body, wherein at least a portion of the handle of clip lever is located above the clip claw so that when the clip assembly in an engaged position, the handle is substantially flush with at least a portion of the clip body.

20. The clip assembly of claim 19, wherein when the clip assembly is in the engaged position and mounted to a frame of an article display system, at least a portion of the handle is located between the frame and the clip body.
